(19) United States
(12) Patent Application Publication
(10) Pub. No.: US 2013/0082548 A1
(43) Pub. Date: Apr. 4, 2013

(54) SWITCHED RELUCTANCE MOTOR

(71) Applicants: Hyung Joon Kim, Seoul (KR); Han Kyung Bae, Gyunggi-do (KR); Jin Wook Baek, Gyunggi-do (KR); Se Joo Kim, Gyunggi-do (KR); Tae Ho Yun, Gyunggi-do (KR); Hong Chul Shin, Gyunggi-do (KR)

(72) Inventors: Hyung Joon Kim, Seoul (KR); Han Kyung Bae, Gyunggi-do (KR); Jin Wook Baek, Gyunggi-do (KR); Se Joo Kim, Gyunggi-do (KR); Tae Ho Yun, Gyunggi-do (KR); Hong Chul Shin, Gyunggi-do (KR)

(73) Assignee: Samsung Electro-Mechanics Co., Ltd., Gyunggi-do (KR)

(21) Appl. No.: 13/494,864

(22) Filed: Jun. 12, 2012

(30) Foreign Application Priority Data
Sep. 30, 2011 (KR) 1020110100131

(51) Int. Cl. H02K 19/02

(52) U.S. Cl. 310/48

(57) ABSTRACT

Disclosed herein is a switched reluctance motor in which a position detection part capable of detecting a rotational position of the rotor part is formed in a balancing member coupled to a rotor part and a sensor part is positioned at a position corresponding to that of the position detection part and on a cover surface of an inner side of the motor housing. According to a preferred embodiment of the present invention, the sensor part is positioned in the motor housing, thereby making it possible to protect the sensor part and improve reliability in sensing of a rotational position of the rotor part by the sensor part.

### CROSS REFERENCE TO RELATED APPLICATION

This application claims the benefit of Korean Patent Application No. 10-2011-0100131, filed on Sep. 30, 2011, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

A switched reluctance motor (SRM) generally called an SR motor rotates a rotor using a reluctance torque according to a change in magnetic reluctance as described in Korean Patent Laid-Open Publication No. 10-2008-0026872. The switched reluctance motor has a low manufacturing cost, hardly requires maintenance, and has a permanent lifespan due to high reliability. The switched reluctance motor is configured to include: a stator part including a stator yoke and a plurality of stator salient poles protruded from the stator yoke; and a rotor part including a rotor core and a plurality of rotor salient poles protruded from the rotor core so as to face the stator salient poles and rotatably received in the stator part.

According to the prior art, in order to detect a rotational position of the rotor part of the switched reluctance motor, a position detection unit for detecting the position of the rotor part is assembled outside the motor, thereby detecting the position of the rotor part.

However, in the case of this method according to the prior art, the entire size of the switched reluctance motor is increased. In addition, since the position detection unit is disposed outside the switched reluctance motor, it is destroyed or damaged due to external impact or foreign materials, thereby deteriorating reliability in an operation. Further, since the position detection unit is disposed outside the switched reluctance motor, an expensive sensor is mounted in order to accurately sense the position of the rotor part, such that a manufacturing cost is increased.

### SUMMARY OF THE INVENTION

The present invention has been made in an effort to provide a switched reluctance motor including a sensor part coupling structure for easily detecting a rotational position of a rotor part of the switched reluctance motor and improving reliability in an operation of a sensor part.

According to a preferred embodiment of the present invention, there is provided a switched reluctance motor including: a shaft forming the rotational center of the motor; a rotor part rotatably coupled to the shaft; a first stopper coupled to an upper portion of the rotor part in an axial direction to thereby support the rotor part; a second stopper coupled to a lower portion of the rotor part in the axial direction to thereby support the rotor part; and a motor housing provided with an opening part through which the shaft penetrates, covering an upper portion of the first stopper in the axial direction, and enclosing outer sides of the rotor part and the second stopper; wherein the first stopper includes a position detection part formed on a surface corresponding to a cover surface of the motor housing at an upper end in the axial direction, and the motor housing includes a sensor part attached on the cover surface thereof so as to correspond to the position detection part.

The rotor part may include an annular rotor core and a plurality of rotor poles protruded outwardly from the rotor core.

The position detection part of the first stopper may include a sensing groove formed at a position complementary to a position of the rotor pole protruded outwardly from the rotor part.

The first stopper may be formed as a balancing member for maintaining rotational balance of the switched reluctance motor.

The sensor part may be a reflective type photo sensor.

The sensor part may be a surface mounted device (SMD) type sensor.

The switched reluctance motor may further include a stator part including: a stator yoke receiving the rotor part therein; and stator salient poles formed to be spaced apart from each other so as to correspond to the rotor pole and formed to be protruded inwardly from the stator yoke.

The motor housing may include a plurality of stator catching jaws formed on an inner side thereof in order to couple the stator yoke thereto and support the stator yoke.

The stator yoke may be coupled to a stator catching jaw in one side direction of the stator catching jaw and the motor housing in the other side direction of the stator catching jaw may further include an air circulation hole formed in order to circulate air to the outside.

### BRIEF DESCRIPTION OF THE DRAWINGS

FIG. 1 is a perspective view of the switched reluctance motor according to the preferred embodiment of the present invention;

FIG. 2 is a partially enlarged perspective view of a surrounding area of a sensor part according to the preferred embodiment of the present invention;

FIG. 3 is a cross-sectional view of a switched reluctance motor according to a preferred embodiment of the present invention;

FIG. 4 is a cross-sectional view showing a coupling state of a stator part of the switched reluctance motor according to the preferred embodiment of the present invention; and

FIG. 5 is a cross-sectional view taken along line A-A′ of FIG. 4.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. In the present invention, an “axial direction” refers to a direction in which a shaft corresponding to the rotational center of the motor is formed. In describing the present invention, a detailed description of related known functions or configurations will be omitted so as not to obscure the gist of the present invention.

Hereinafter, preferred embodiments of the present invention will be described in detail with reference to the accompanying drawings.

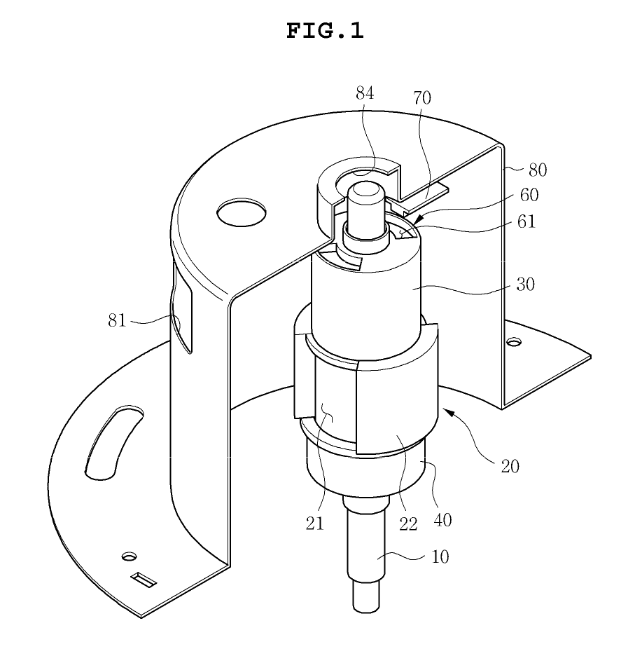

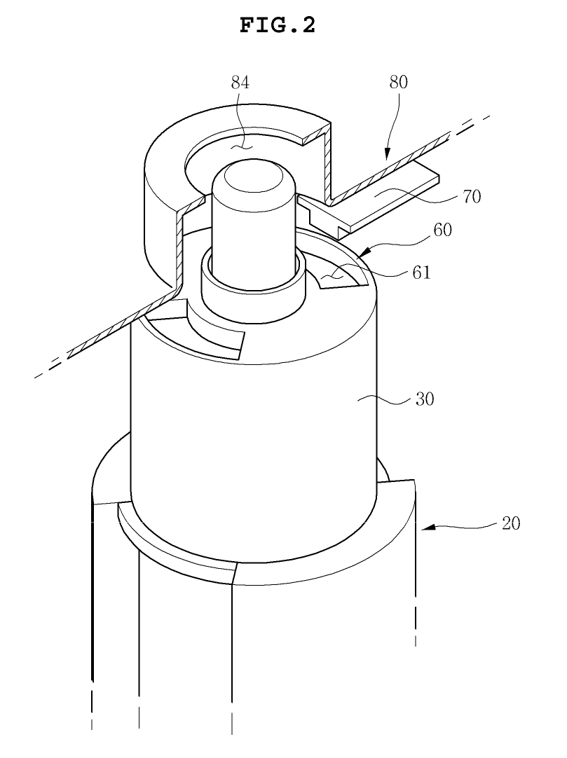

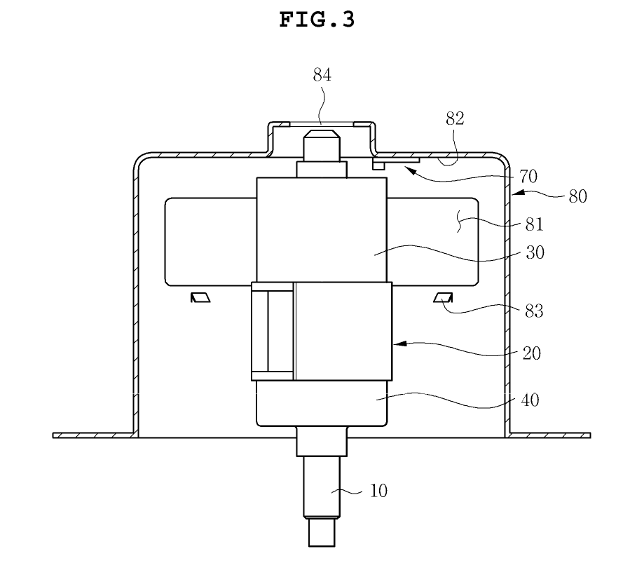

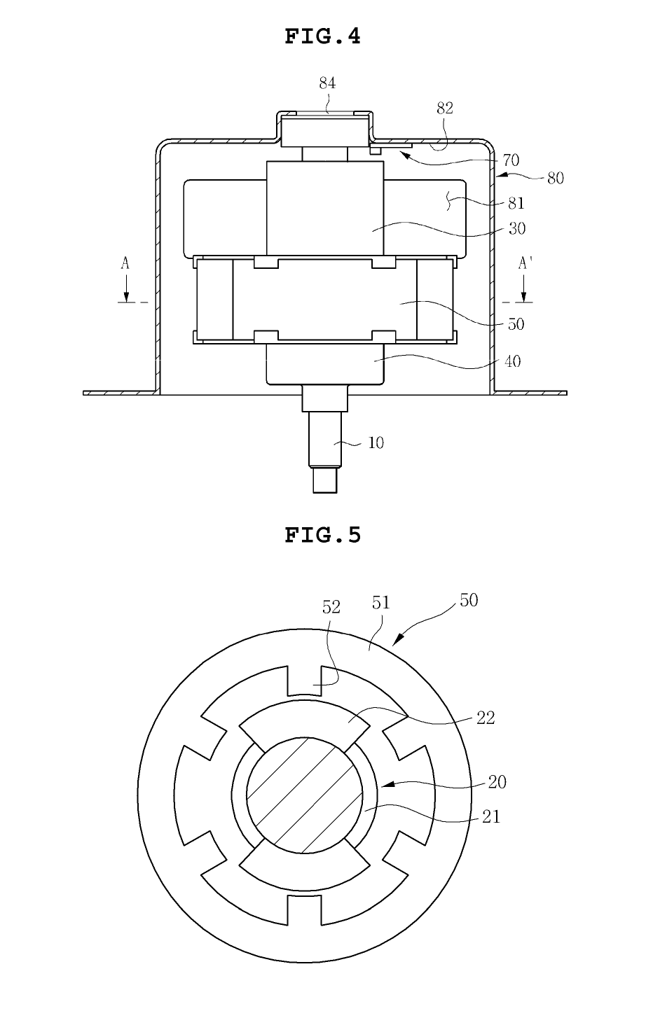

FIG. 1 is a perspective view of the switched reluctance motor according to the preferred embodiment of the present invention; FIG. 2 is a partially enlarged perspective view of a surrounding area of a sensor part according to the preferred embodiment of the present invention; FIG. 3 is a cross-sectional view of a switched reluctance motor according to a preferred embodiment of the present invention; FIG. 4 is a cross-sectional view showing a coupling state of a stator part of to the switched reluctance motor according to the preferred embodiment of the present invention; and FIG. 5 is a cross-sectional view taken along line A-A′ of FIG. 4.

The switched reluctance motor according to the preferred embodiment of the present invention is configured to include a shaft 10 forming the rotational center of the motor; a rotor part 20 rotatably coupled to the shaft 10; a first stopper 30 coupled to an upper portion of the rotor part 20 in an axial direction to thereby support the rotor part 20; a second stopper 40 coupled to a lower portion of the rotor part 20 in the axial direction to thereby support the rotor part 20; and a motor housing 80 provided with an opening part through which the shaft 10 penetrates, covering an upper portion of the first stopper 30 in the axial direction, and enclosing outer sides of the rotor part 20 and the second stopper 40, wherein the first stopper 30 includes a position detection part 60 formed on a surface corresponding to a cover surface 82 of an inner side of the motor housing 80 at an upper end in the axial direction, and the motor housing 80 includes a sensor part 70 attached on the cover surface 82 thereof so as to correspond to the position detection part 60.

The shaft 10 forms the rotational center of the motor and is extended in the axial direction. Particularly, the axial direction in the present invention, which is based on a direction in which the shaft 10 is formed, refers to directions toward upper or lower portions based on the shaft 10 shown in FIG. 1.

The rotor part 20 may be configured to include an annular rotor core 21 and a plurality of rotor poles 22 protruded outwardly from the rotor core 21. The rotor core 21 has a hollow hole formed at a central portion thereof, and the shaft 10 is fixedly coupled to the hollow hole to thereby transfer rotation of the rotor part 20 to the outside. A plurality of rotor poles 22 are formed to be protruded outwardly along an outer circumferential surface of the rotor core 21 and may be formed to correspond to a stator salient pole 52 to be described below.

The first stopper 30 is coupled to the upper portion of the rotor part 20 in the axial direction to thereby serve to support the rotor part 20. The first stopper 30 is coupled to the shaft 10 while supporting the rotor part 20, thereby rotating together with the rotor part 20. The first stopper 30 supports the rotor part 20 in the axial direction and may be made of a resin such as a plastic, or the like, to thereby be formed as a balancing member capable of adjusting rotational balance at the time rotation of the motor. When the first stopper is used as the balancing member, it senses a position at which rotational unbalance is generated and performs a cutting-process, thereby making it possible to balance the rotation of the motor. The balancing member may be formed by processing a plastic, or the like, or be formed integrally with the rotor part 20 through injection-molding. The first stopper 30 may be provided with the position detection part 60 for sensing a rotational position through a position of the rotor pole 22 of the rotor part 20 by rotating together with the rotor part 20.

The position detection part 60, which is to sense the position of the rotor pole 22 of the rotor part 20 to thereby sense the rotational position of the rotor part 20, may include a sensing groove 61 formed at a position complementary to the position of the rotor pole 22 protruded from the rotor core 21. As shown in FIGS. 2 and 3, the first stopper 30 may include the sensing groove 61 formed in an upper end surface thereof corresponding to the cover surface 82 of the inner side of the motor housing 80 covering an upper end portion thereof in the axial direction. The sensor part 70 may be mounted on the cover surface 82 of the inner side of the motor housing 80 in the axial direction so as to correspond to the sensing groove 61 in a vertical direction. The sensor part 70 may be formed by attaching a sensor on a printed circuit board 71, and a configuration of the sensor part 70 may properly change the design so as to be appropriate for a sensor used as the sensor part 70.

The sensor part 70 is formed at a position corresponding to the position detection part 60 described above. That is, the sensing groove 61 is formed in the upper end surface of the first stopper 30, and the sensor part 70 is attached to the cover surface 82 of the inner side of the motor housing 80 in a state in which it is spaced apart from the sensing groove 61 in the vertical direction. As the sensor part 70, a reflective type photo sensor may be used. A photo sensor is attached to the cover surface 82 of the motor housing so as to vertically irradiate the sensing groove 61 with light, thereby making it possible to detect the rotational position of the rotor part 20 through a difference in sensed values obtained through reflection of light irradiated to a portion at which the sensing groove 61 is formed and a portion at which the sensing groove 61 is not formed at the time of the rotation of the motor. As the sensor part 70, a surface mounted device (SMD) type sensor is used, thereby making it possible to reduce a cost and secure accuracy and reliability in sensing as compared to the sensor having the structure according to the prior art.

The second stopper 40 is coupled to the lower portion of the rotor part 20 in the axial direction to thereby serve to support the rotor part 20. The second stopper 40 has a configuration similar to that of the first stopper 30 described above. In addition, a material and a manufacturing method of the second stopper 30 are the same at those of the first stopper 30 described above. The second stopper 40 may also be made of a plastic material to thereby be used as a balancing member in order to maintain balance for rotation of the rotor part 20 Although not shown, it is obvious to those skilled in the art to change the design so as to detect the rotational position of the rotor part 20 by forming the sensing groove 61 in a lower end surface of the second stopper 40 in the axial direction and forming the sensor part 70 formed at a position corresponding to that of the sensing groove 61 formed in the lower end surface of the second stopper 40.

As shown in FIGS. 4 and 5, the stator part 50 is configured to include a stator yoke 51 and stator salient poles 52. The stator yoke 51 may include a hollow hole formed so as to receive the rotor part 20 therein, and a plurality of stator salient poles 52 may be formed to be protruded from an inner side of the stator yoke 51 and correspond to the rotor parts 22 of the rotor pole 20. Current is applied to the stator salient poles 52 of the stator yoke 51 to form a magnetic flux path through the stator salient pole 52 and the rotor poles 22 of the rotor part 20 facing the stator salient poles 52, such that the rotor part 20 rotates.

The stator part 50 may be coupled to the motor housing 80 by being caught by the stator catching jaw 83 formed on the inner side of the motor housing 80, as shown in FIG. 1. The stator part 50 may be coupled to the motor housing 80 to enclose an outer side of the rotor part 20 without impeding an air circulation hole 81 formed in the inner side of the motor housing 80. The air circulation hole 81 circulates air to the outside to thereby serve to circulate heat generated in the motor housing 80 or air.

The motor housing 80 may be formed to enclose the first stopper 30, the rotor part 20, and the second stopper 40, and include the cover surface 82 covering the upper end surface of the first stopper 30 in the axial direction, wherein the cover surface 82 may be provided with the opening part 84 so that the shaft 10 may penetrate therethrough in the axial direction. The motor housing 80 protects internal components thereof such as the rotor part 20, the stator part 50, and the like, and prevents other foreign materials from being introduced thereinto, thereby improving reliability in the operation of the motor.

According to the preferred embodiment of the present invention, the stoppers are formed at the upper and lower portions of the rotor part in the axial direction in order to fix the rotor part of the switched reluctance motor and the rotation of the rotor part is sensed through a structural change of the stoppers, such that a separate member for sensing is not required, thereby making it possible to easily assemble the motor and improve productivity of the motor.

In addition, the sensor part for sensing the rotational position of the rotor part is included in the housing of the switched reluctance motor to protect the sensor part from external impact or introduction of foreign materials from the outside, thereby making it possible to improve performance and reliability in the operation of the sensor part.

Further, the stopper supporting the rotor part of the switched reluctance motor on one side thereof in the axial direction is used as the balancing part and the upper end portion of the balancing part in the axial direction is provided with the position detection part of which the position is sensed by the sensor part, thereby making it possible to improve performance of the operation of the switched reluctance motor and reliability in the sensing of the sensor part.

Furthermore, the surface mounted device (SMD) type sensor is used as the sensor part to reduce a manufacturing cost of the switched reluctance motor, thereby making it possible to increase a yield of a product.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A switched reluctance motor comprising:
a shaft forming the rotational center of the motor;
a rotor part rotatably coupled to the shaft;
a first stopper coupled to an upper portion of the rotor part in an axial direction to thereby support the rotor part;
a second stopper coupled to a lower portion of the rotor part in the axial direction to thereby support the rotor part; and
a motor housing provided with an opening part through which the shaft penetrates, covering an upper portion of the first stopper in the axial direction, and enclosing outer sides of the rotor part and the second stopper;
wherein the first stopper includes a position detection part formed on a surface corresponding to a cover surface of the motor housing at an upper end in the axial direction, and the motor housing includes a sensor part attached on the cover surface thereof so as to correspond to the position detection part.

2. The switched reluctance motor as set forth in claim 1, wherein the rotor part includes an annular rotor core and a plurality of rotor poles protruded outwardly from the rotor core.

3. The switched reluctance motor as set forth in claim 2, wherein the position detection part of the first stopper includes a sensing groove formed at a position complementary to a position of the rotor pole protruded outwardly from the rotor part.

4. The switched reluctance motor as set forth in claim 1, wherein the first stopper is formed as a balancing member for maintaining rotational balance of the switched reluctance motor.

5. The switched reluctance motor as set forth in claim 1, wherein the sensor part is a reflective type photo sensor.

6. The switched reluctance motor as set forth in claim 1, wherein the sensor part is a surface mounted device (SMD) type sensor.

7. The switched reluctance motor as set forth in claim 1, further comprising a stator part including:
a stator yoke receiving the rotor part therein; and
stator salient poles formed to be spaced apart from each other so as to correspond to the rotor pole and formed to be protruded inwardly from the stator yoke.

8. The switched reluctance motor as set forth in claim 6, wherein the motor housing includes a plurality of stator catching jaws formed on an inner side thereof in order to couple the stator yoke thereto and support the stator yoke.

9. The switched reluctance motor as set forth in claim 7, wherein the stator yoke is coupled to a stator catching jaw in one side direction of the stator catching jaw and the motor housing in the other side direction of the stator catching jaw further includes an air circulation hole formed in order to circulate air to the outside.
